(19) United States
(12) Patent Application Publication
(10) Pub. No.: US 2015/0015707 A1
(43) Pub. Date: Jan. 15, 2015

(54) TELEPRESENCE METHOD AND SYSTEM FOR TRACKING HEAD MOVEMENT OF A USER

(71) Applicant: SUBC CONTROL LIMITED, Clarenville (CA)

(72) Inventors: Chad Joseph COLLETT, Clarenville (CA); Adam Paul ROWE, Clarenville (CA)

(21) Appl. No.: 13/938,695

(22) Filed: Jul. 10, 2013

(51) Int. Cl. H04N 7/18; H04N 5/232; B60R 1/00

(52) U.S. Cl. CPC H04N 7/185; B60R 1/002; H04N 5/232; H04N 5/23219
USPC 348/148

(57) ABSTRACT

A telepresence system and method is disclosed for removing error introduced to video images displayed to a user. A remote pan and tilt system tracks the motion of the user's head, and moves a pan and tilt system to capture images of the remote environment. By sensing noise in the movement of the user and/or the motion of the vehicle, error caused by noise is reduced within the displayed video images.

### FIELD OF INVENTION

The present invention relates to telepresence and more particularly to a telepresence method and system for tracking the head movement of a user.

### BACKGROUND

Telepresence technology enables a user positioned at a first location to feel as though they are present at a second remote location. Visual and audio information that is normally detected at the second location by the user is provided to the user's senses, artificially “immersing” the user in the remote environment. Advanced telepresence systems give the user the ability to change the ‘point of view’ of their environment simply by moving their head in the direction they wish to see.

A benefit of telepresence technology is the ability for humans to ‘experience’ a situation without being physically present. This is advantageous in harsh and limited access environments such as underground, underwater, extreme climates, and even outer space. The risks posed to humans by a harsh environment are eliminated, while still enabling the collection of environmental information. Vehicles and robots equipped with telepresence systems are used for various applications in harsh environments, such as in mining, deep sea applications, space exploration and sample collection, bomb removal, military applications, etc. However, the motion of the vehicle introduces aberrations into the user “experience”—mainly the image projected to the user. Furthermore, when the user is a passenger of a vehicle during a telepresence session, the movement of the vehicle also introduces unwanted motion to the system. For instance, on an ocean vessel the wave motion rocks the vessel, and thus rocks the user, influencing the image projected to the user.

It would be beneficial to provide a method and system that overcome at least some of the above-noted disadvantages.

### SUMMARY OF THE EMBODIMENTS OF THE INVENTION

In accordance with an aspect of the invention there is provided a method comprising sensing the movement of a head of a user with a first sensor; providing by the first sensor a first signal indicative of the sensed movement of the head of the user; coupling a second sensor to a vehicle and sensing the movement of the vehicle with the second sensor; providing by the second sensor a second signal, the second signal comprising a component indicative of the sensed movement of the vehicle; cancelling an error from the first signal comprising cancelling the component of the second signal indicative of the sensed movement of the vehicle to provide a third signal; and moving a pan and tilt system in correlation with the third signal.

In accordance with an aspect of the invention there is provided another method comprising aligning a remote pan and tilt system (PATS) with the position of a head of a user wherein aligning comprises aligning the remote pan and tilt system with the position of the head of the user to define a set of aligned positions therebetween {(p1head,p1pats), (p2head, p2pats) (p3head, p3pats), . . . } such that moving the head of the user from a first aligned position p1head in alignment with the pan and tilt system at p1pats to a second other position p2head results in automatic motion of the pan and tilt system to a second PATS position p2pats in alignment with the second other position p2head; after moving the remote pan and tilt system to maintain alignment with the movement of the head of the user, detecting automatically misalignment between a detected position of the remote pan and tilt system and a detected position of the head of the user; and in response to automatically detecting misalignment, automatically realigning the relative position between the remote pan and tilt system with the head of the user to correct for the misalignment.

In accordance with an aspect of the invention there is provided a system comprising a first sensor for sensing movement of a head of a user and for transmitting a first signal indicative of the sensed movement of the head of the user; a vehicle sensor for sensing movement of a vehicle and for transmitting a second signal indicative of the sensed movement of the vehicle; a receiver for receiving the first signal and the second signal; a processor for cancelling error based on the second signal from the first signal to produce a third signal; and a remote pan and tilt system disposed remote from the first sensor and comprising a controller, movement of the remote pan and tilt system dependent upon the third signal.

### BRIEF DESCRIPTION OF THE DRAWINGS

FIG. 1 is a simplified block diagram of a prior art telepresence system.

FIG. 2 is a simplified block diagram of another prior art telepresence system.

FIG. 3 is a simplified block diagram of a head tracking telepresence system with a vehicle sensing device coupled to a head mounted device.

FIG. 4 is a simplified block diagram of another head tracking telepresence system with a vehicle sensing device coupled to a pan and tilt system.

FIG. 5 is a simplified block diagram of a head tracking telepresence system wherein vehicle movement error is detected and removed.

FIG. 6 is a simplified block diagram of another head tracking telepresence system wherein the telepresence system becomes misaligned.

FIG. 7 is a simplified block diagram of a head tracking telepresence system obstructed by an object.

FIG. 8 is a top view of a simplified block diagram of a head tracking telepresence system with a delayed response.

### DETAILED DESCRIPTION OF THE EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

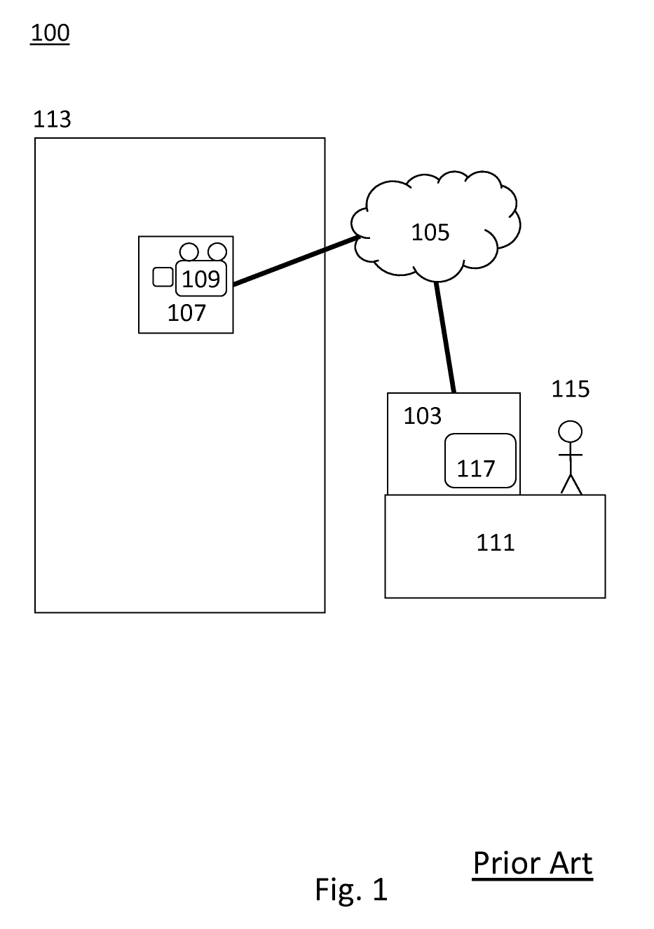

Shown in FIG. 1, is a simplified block diagram of a prior art telepresence system 100 comprising a user head tracking system 103 coupled to a communication network 105, and a video camera apparatus 107, also coupled to the communication network 105. The video camera apparatus 107 controls three-dimensional movement of video camera 109 intended for exploring harsh environment 113, for example a region of the ocean floor. User 115 is located on a vehicle remote from harsh environment 113, for example a vessel 111 on the ocean surface. The head of user 115 is monitored by head tracking system 103, such that upon movement of the user's head, the head tracking system 103 transmits data indicative of the movement to the video camera apparatus 107. The video camera 109 moves in synchronous motion to the head of user 115, and the video camera apparatus 107 transmits video information to display 117 of the head tracking system 103. Movement of vessel 111 caused by ocean waves is also sensed by head tracking system 103, however, it is not differentiated from the intended motion of the user's head. Thusly, the image displayed to user 115 on display 117 moves with the heave of the vessel 111. Furthermore, any other motion of vessel 111 has a similar undesired effect on the image displayed on display 117.

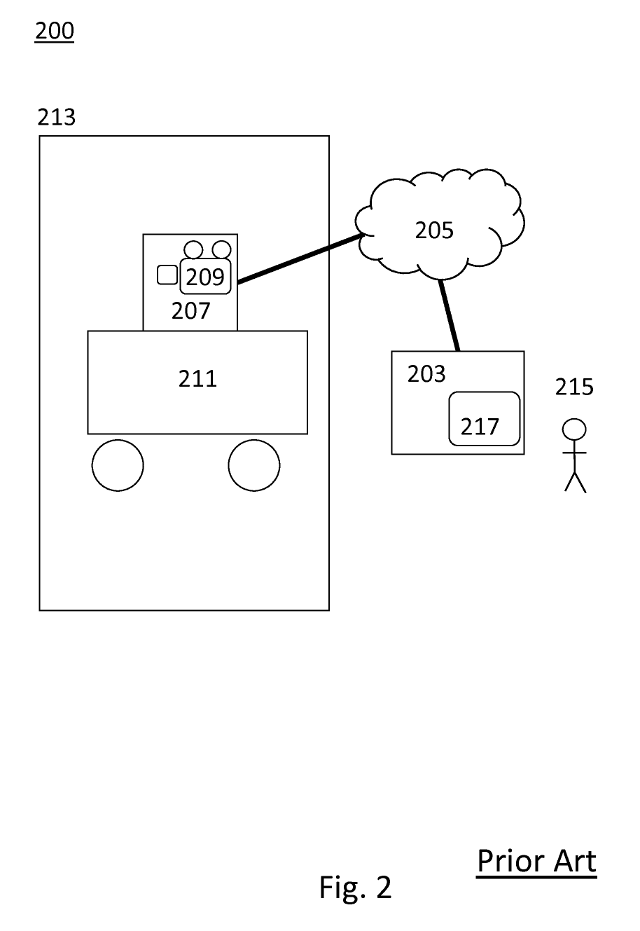

Shown in FIG. 2 is another simplified block diagram of a prior art telepresence system 200 comprising a user head tracking system 203 coupled to a communication network 205 and a video camera apparatus 207, also coupled to the communication network 205. The video camera apparatus 207 controls three-dimensional movement of video camera 209 and is attached to a remotely controlled vehicle 211, intended for exploring harsh environment 213. User 215 is located remotely from harsh environment 213. The head of user 215 is monitored by head tracking system 203, such that upon movement of the user's head, the head tracking system 203 transmits data indicative of the movement to the video camera apparatus 207. Video camera 209 moves in synchronous motion to the head of user 215, and the video camera apparatus 207 transmits captured video information to display 217 of the head tracking system 203. Vibration of remotely controlled vehicle 211 causes the video camera 209 to vibrate and this high speed movement translates to a vibration of the image displayed on the display 217. Furthermore, as the remotely controlled vehicle 211 travels along the contour of the landscape, it may tilt or move in other unwanted directions having undesired effects on the image that is displayed on display 217.

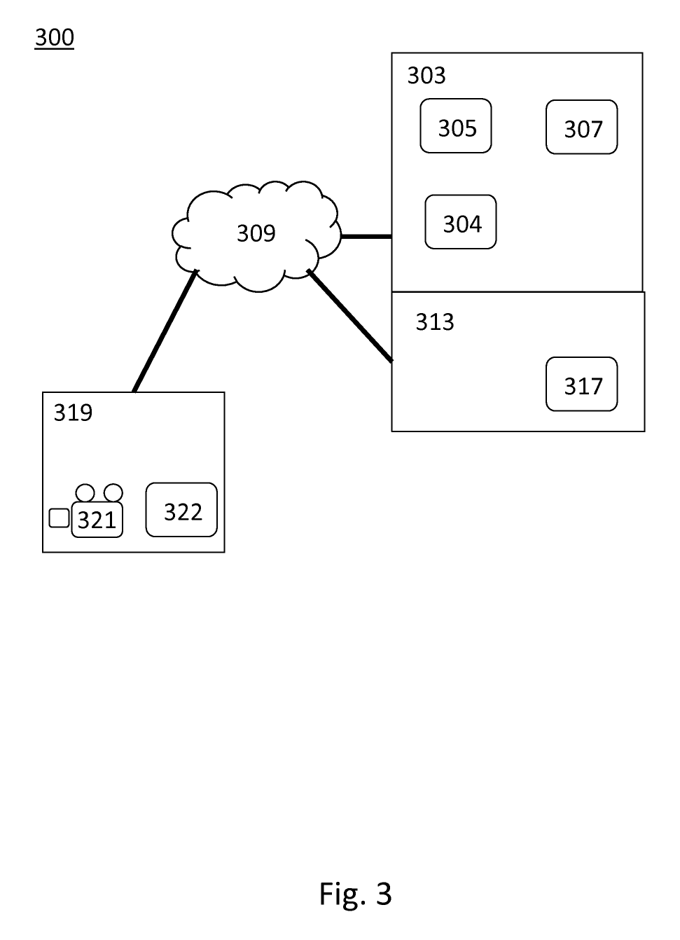

Shown in FIG. 3 is a simplified block diagram of a head tracking telepresence system according to an embodiment of the invention. Telepresence system 300 comprises a head mounted device 303, pan and tilt apparatus 319, vehicle sensing device 313, all of which are coupled to communication network 309. The user is a passenger of the vehicle. Communication technology used in communication network 309 includes, but is not limited to, fibre optic, wireless, coax, twisted pair, or a combination of communication technologies. Further optionally, communication network 309 comprises a LAN, WAN, the Internet, point-to-point configuration, or any network combination thereof.

Head mounted device 303 is formed to securely fit onto the head of a user (not shown) and comprises a motion sensor 305 for sensing the directional movement of the user's head, video display 307, and processor 304. Alternatively, the video display 307 is other than coupled to the head mounted device 303. The processor transmits movement instruction data primarily based on the directional movement of the user's head to the pan and tilt apparatus via the communication network 309. Optionally, the telepresence system processor 304 is located on a server (not shown) coupled to network 309.

Optionally, head mounted device 303 also comprises a speaker (not shown). Optionally, head mounted device 303 comprises a plurality of speakers to provide stereo sound to a user.

Pan and tilt apparatus 319 comprises video camera 321 and motor control device 322. Optionally, the pan and tilt apparatus 319 comprises a plurality of video cameras for providing stereoscopic vision to the user (not shown) on display 307. The motor control device 322 moves the video camera 321 in the direction indicated by the received movement instruction data from the head mounted device 303. Furthermore, the image captured by the video camera 321 is translated into video data and is transmitted to the head mounted device 303 via the communication network 309. The image is then displayed on the video display 307 of the head mounted device 303. In some embodiments the image is displayed on a video screen or a plurality of video screens.

Vehicle sensing device 313 is coupled to a vehicle (not shown) of which the user is a passenger, and comprises a motion sensor 317. Motion sensor 317 senses the motion of the vehicle. Vehicle motion data, indicative of the motion of the vehicle, is transmitted to the head mounted device 303 via communication network 309. Alternatively, the vehicle motion data is transmitted directly to head mounted device 303.

The vehicle's movement is also sensed by head tracking apparatus 303 since the user is located in the vehicle, however, the vehicle's movement is not discernable by motion sensor 305 separate from the motion of the user's head. Accordingly, if the movement instruction data for instructing the movement of the video camera 321 is based solely on the motion sensed by motion sensor 305—of the head mounted device 303—then the pan and tilt apparatus not only moves synchronously to the user's head, but also to the movement of the vehicle. As such, the image displayed on video display 307 also moves with the movement of the vehicle. To remove the effect of the vehicle's motion on the pan and tilt apparatus 319, processor 304, using the received vehicle motion data sensed by motion sensor 317, removes the error introduced by the movement of the vehicle from the sensor 305 data, and transmits movement instruction data to the pan and tilt apparatus based on the motion of the user's head relative to the motion of the vehicle. Reduction of the effect of the vehicle motion on the telepresence system provides a more realistic and less nauseating experience to the user.

Similarly, if the user does not move their head while the vehicle is moving, then pan and tilt apparatus 319 remains stationary.

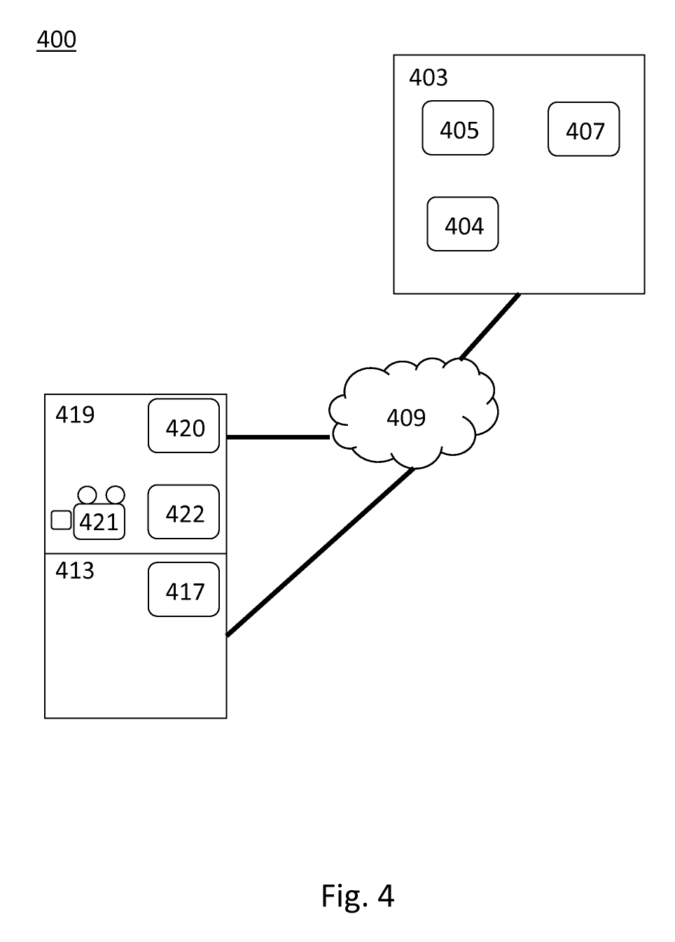

Shown in FIG. 4 is a simplified block diagram of another telepresence system according to an embodiment of the invention. Telepresence system 400 comprises a head mounted device 403, pan and tilt apparatus 419, vehicle sensing device 413, all of which are coupled to communication network 409. Communication technology used in communication network 409 includes, but is not limited to, fibre optic, wireless, coax, twisted pair, or a combination of communication technologies. Further optionally, communication network 409 comprises a LAN, WAN, the Internet, point-to-point configuration, or any network combination thereof.

Head mounted device 403 is formed to securely fit onto the head of a user (not shown) and comprises a motion sensor 405, for sensing the directional movement of the user's head, video display 407, and processor 404. Alternatively, the video display 407 is other than coupled to the head mounted device 403. The processor transmits movement instruction data primarily based on the directional movement of the user's head to the pan and tilt apparatus 419 via the communication network 409. Optionally, the telepresence system processor 404 is located on a server (not shown) coupled to network 409.

Optionally, head mounted device 403 also comprises a speaker (not shown). Optionally, head mounted device 403 comprises a plurality of speakers to provide stereo sound to a user.

Pan and tilt apparatus 419 comprises video camera 421 and motor control device 422. Optionally, the pan and tilt apparatus 419 comprises a plurality of video cameras for providing stereoscopic vision to the user (not shown) on display 407. The motor control device 422 moves the video camera 421 in the direction indicated by the received movement instruction data from the head mounted device 403. Furthermore, the image captured by the video camera 421 is translated into video data and is transmitted to the head mounted device 403 via the communication network 409. The image is then displayed on the video display 407 of the head mounted device 403. In some embodiments the image is displayed on a video screen or a plurality of video screens.

Vehicle sensing device 413 comprises motion sensor 417 and is coupled to a vehicle (not shown), to which the pan and tilt apparatus 419 is also coupled. Motion sensor 417 senses motion of the vehicle. Vehicle motion data, indicative of the motion of the vehicle, is transmitted to the head mounted device 403 via communication network 409.

If the movement instruction data for instructing the movement of the video camera 421 is based solely on the motion sensed by motion sensor 405, of the head mounted device 403, then the video camera 421 moves synchronously to the user's head, however the entire pan and tilt apparatus 419 moves with the movement of the vehicle to which it is affixed. As such, the image displayed to the user also moves with the movement with the vehicle 413.

To reduce the effect of the vehicle's motion on the image displayed to the user, processor 404, based on the sensor 405 data and the vehicle motion data, transmits movement instruction data to the pan and tilt apparatus 419 that counters the error introduced by the movement of the vehicle. Reduction of the effect of the vehicle motion on the telepresence system provides a more realistic and less nauseating experience to the user.

Alternatively, error introduced to the telepresence system by the movement of the vehicle is other than corrected. For example, a pan and tilt apparatus of a telepresence system is coupled to a vehicle comprising a remote control robotic arm. A user of the telepresence system navigates the robotic arm in an attempt to collect a specimen, such as a rock. The vibration of the vehicle engine causes the robotic arm to also vibrate. To more accurately visualize the true movement of the robotic arm relative to the rock the user turns the automatic error correction ‘OFF.’ A specific and non-limiting example is the user turns a switch to the ‘OFF’ position. Alternatively, the user provides an ‘OFF’ command via a console of the telepresence system. Alternatively, the user provides a verbal command to turn the automatic error correction ‘OFF.’ The vibration of the vehicle is then apparent on the image displayed to the user. On the other hand, if the automatic error correction remains ‘ON’, the image does not vibrate and therefore does not represent a realistic view of the actual movement of the robotic arm relative to the rock.

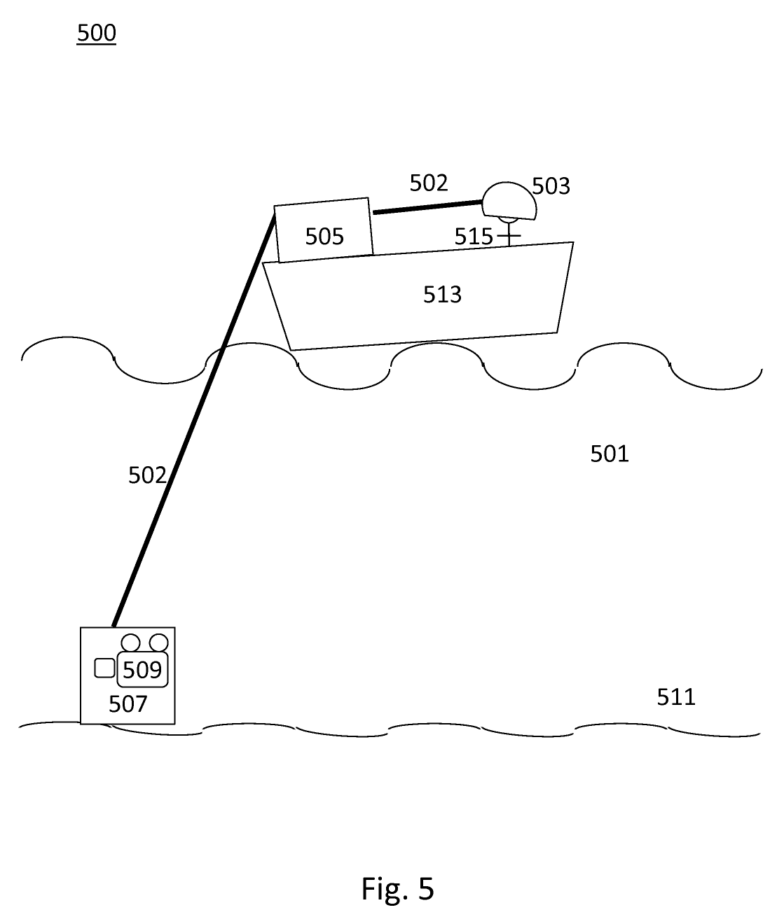

Referring now to FIG. 5, shown is a simplified block diagram of a head tracking telepresence system according to an embodiment of the invention. Telepresence system 500 comprises head mounted device 503, vehicle sensing device 505 and pan and tilt apparatus 507, all of which are coupled to communication network 502. In this example, network 502 comprises a point-to-point network. Optionally, communication network 502 comprises a LAN, WAN, the Internet, point-to-point configuration, or any network combination thereof. Optionally, communication technology used in communication network 502 includes, but is not limited to, fibre optic, wireless, coax, twisted pair, or a combination of communication technologies.

Head mounted device 503 is formed to fit securely onto the head of a user 515, and comprises a motion sensor for sensing the directional movement of the user's head and a video display. Alternatively, the video display is other than coupled to the head mounted device. In this example, head mounted device 503 is in the form of a helmet and the video display comprises a video screen positioned on the helmet visor for viewing by the user 515. Optionally, the head mounted device 503 is other than a helmet and comprises a video display for viewing by user 515. Vehicle sensing device 505 is coupled to a vehicle, for example a ship 513 on ocean 501, and comprises a motion sensor for sensing the motion of the ship 513. User 515 is a passenger of ship 513. Ship motions include, but are not limited to, roll, pitch and yaw. The ship may also vibrate due to the ship's engine or other equipment running. Pan and tilt apparatus 507 is located on the ocean floor 511 and comprises a video camera 509. Optionally, the pan and tilt apparatus 507 comprises a plurality of video cameras for providing stereoscopic vision to the user 515 on display (not shown). In some embodiments the image is displayed on a video screen or a plurality of video screens. Pan and tilt apparatus 507 moves the video camera 509 in three-dimensions based on instructions provided by a telepresence system processor. In this example, vehicle sensing device 505 comprises the telepresence system processor. Optionally, head mounted device 503 comprises the telepresence system processor. Optionally, the telepresence system processor (not shown) is located on a server (not shown) coupled to network 502.

The motion of the user's head is sensed by the head mounted device 503 and an indication of the motion of the user's head is transmitted to the telepresence system processor via communication network 502. Meanwhile, ship 513 is moving under the influence of the ocean 501 waves, for example, causing ship 513 to pitch up and down. The movement of ship 513 is sensed by the head mounted device, however, the ship motion is not discernable from the motion of the user's head.

If the movement instruction data for instructing the movement of the video camera 509 is based solely on the motion sensed by the head mounted device 503, then the video camera 509 moves synchronously to the user's head, however the video camera 509 also moves with the movement of ship 513. For example, in response to the user moving their head to the right, the video camera 509 also move to the right. Additionally, however, the video camera 509 also moves up and down in response to the movement of ship 513. As such, the image displayed to the user represents the field of view to the right side of the pan and tilt apparatus, and is constantly moving up and down.

To remove the effect of the ship's motion on the video camera 509 movement, and thus the image that is displayed to user 515, the telepresence system processor removes the error introduced by the movement of ship 513 from the head mounted device 503 sensor data, and transmits movement instruction data to pan and tilt apparatus 507 based on the motion of the user's head relative to the motion of ship 513. Reduction of the effect of ship 513 motion on the telepresence system provides a more realistic and less nauseating experience to the user 515.

Alternatively, ship 513 is vibrating, and the processor removes the error introduced by the vibration of ship 513 from the head mounted device 503 sensor data, and transmits movement instruction data to pan and tilt apparatus 507 based on the motion of the user's head relative to the motion of ship 513. Alternatively, the vehicle is other than a ship. Alternatively, the vehicle is a terrestrial vehicle.

Alternatively, removal of the error introduced by the movement of ship 513 is achieved by counter rotating the movement of the video camera 509 relative to the ship 513. For example, when the ship turns 3 degrees north, the user view automatically turns 3 degrees south to keep a consistent gaze.

Upon removal of an error introduced to a telepresence system by the movement of a vehicle, as described in the embodiments above, an indication that the error is being removed is provided to the user. For example, a telepresence system counter-rotates the movement of a video camera relative to the movement of a vehicle the pan and tilt apparatus is coupled thereto. During the counter-rotation movement of the video camera an indication of the ongoing error correction is provided to the user. A specific and non-limiting example is a visual cue such as a light flashing. Alternatively, an audible cue is provided to the user. Alternatively, a portion of the telepresence system vibrates to indicate the ongoing error autocorrection to the user.

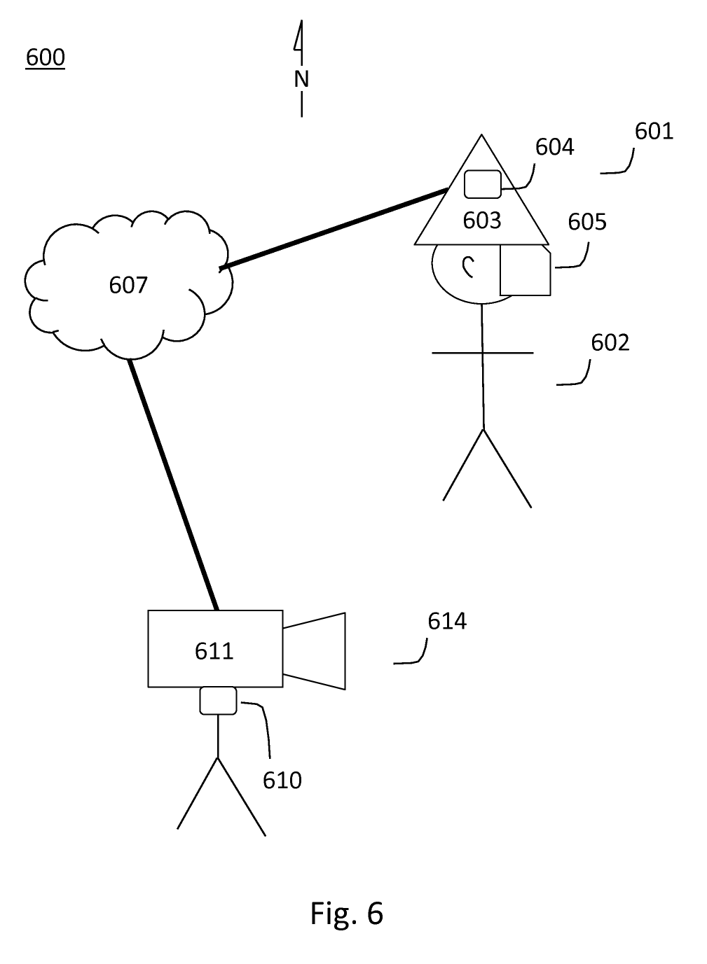

Now referring to FIG. 6, shown is a simplified embodiment of another head tracking telepresence system according to an embodiment of the invention. Telepresence system 600 comprises a head mounted device 601, pan and tilt apparatus 614 and a communication network 607. Both of the head mounted device 601 and pan and tilt apparatus 614 are coupled to the communication network 607. The telepresence system also comprises a processor (not shown) coupled to the communication network 607 for processing data. In this example, head mounted device 601 comprises a helmet 603, display 605 and motion sensor 604 for sensing the movement of the head of user 602. Alternatively, the head mounted device comprises other than a helmet. Alternatively, the head mounted device comprises an apparatus for fixing a display to a user's head. Alternatively, the video display 605 is other than coupled to the head mounted device 601. Pan and tilt apparatus 614 is located remotely from user 602 and comprises video camera 611 and motor 610 for moving the camera in 3 dimensions. Alternatively, the pan and tilt apparatus 614 comprises a plurality of video cameras for providing stereoscopic vision to the user 602 on display 605. Further alternatively, a plurality of motors are used for moving the cameras in 3 dimensions.

As the user 602 moves their head to various positions, instructions are transmitted to the pan and tilt apparatus 614, via the communication network 607, instructing the pan and tilt apparatus 614 to move the video camera 611 such that it tracks the movement of the user's head. The movement of the pan and tilt apparatus 614 may lag the movement of the user's head. The lag depends on the speed of the user's head and the response time of the telepresence system, and possibly also the distance between the user 602 and telepresence system 614. Video data is transmitted via the communication network 607 for displaying the images captured by the video camera 611 on display 605. For example, user 602 moves their head east, sensor 604 detects the motion, and instructions are transmitted via communication system 607 instructing the pan and tilt apparatus 614 to point toward the east. Motor 610 moves the video camera 611 east. Image data showing east is transmitted back to head mounted device 601 via communication network 607. As the user 602 moves their head, the pan and tilt apparatus 614 follows, constantly transmitting video data for viewing by the user. User 602 is ‘virtually immersed’ in the environment of the pan and tilt apparatus 614. In some embodiments the image is displayed on a video screen or a plurality of video screens.

For example, the user's head located in position {x1, y1, z1} corresponds to the pan and tilt apparatus 614 position of {x1′,y1′,z1′}, the user's head located in position {x2, y2, z2} corresponds to the pan and tilt apparatus 614 position of {x2′,y2′,z2′}, and so forth.

Simultaneous to the movement of the user's head, feedback data indicating the position of the pan and tilt apparatus 614 is provided to the processor. Also provided to the processor is the position of the user's head. While in use, the pan and tilt apparatus comes out of alignment with the position of the user's head. For example, the user's head is in position {x1, y1, z1} however the pan and tilt apparatus 614 is in position {x3′,y3′,z3′}. Comparing the feedback data with the known position of the user's head, the misalignment is automatically detected by the processor. For continued use of the telepresence system, the misalignment is corrected. Optionally, the telepresence system automatically corrects the misalignment. For example, pan and tilt apparatus 614 automatically moves to the position {x4′,y4′,z4′} that corresponds to the current position of the user's head {x4,y4,z4}. Then the telepresence system resumes normal operation of tracking the user's head.

Optionally, the telepresence system provides an indication to the 602 that a misalignment has occurred. For example, a visual cue appears on the display indicating to user 602 that the telepresence system is misaligned. Alternatively, an audible cue is provided to the user. Alternatively, a portion of the telepresence system vibrates to indicate a misalignment to user 602.

Still referring to FIG. 6, upon detection of misalignment between the position of the user's head and the pan and tilt apparatus 614, a cue indicating the misalignment requires correction is provided to the user. For example, a text message appears on the display 605. To correct for the misalignment, a position {x1,y1,z1} is displayed on the display for guiding the user to move their head to that position. The user 614 moves their head to position {x1,y1,z1}. The pan and tilt apparatus 614 moves to the corresponding position {x1′,y1′,z1′}. Then the telepresence system resumes normal operation of tracking the user's head. Alternatively, the telepresence system mechanically guides the user's head to position {x1,y1,z1} and pan and tilt apparatus 614 moves to the corresponding position. Alternatively, user 602 is requested to move their head to a previously known position and the pan and tilt apparatus moves to the corresponding position.

A pan and tilt apparatus has a known range of motion determined by physical limitations of the telepresence system. For example, pan and tilt apparatus 614 other than moves 360° in any direction. In this example, the motor limits the range of motion of the video camera to 90° from the origin in the x, y and z coordinate system. However, many users have the ability to turn their heads left and right beyond 90°. Misalignment between a position of the user's head and a pan and tilt apparatus may be due to the user extending their head beyond the limits of the range of motion of the pan and tilt apparatus. When misalignment due to a range of motion error is detected by the telepresence system a cue indicating the cause of the misalignment is provided to the user. For example, a text message such as ‘out of range” appears on the display of a head mounted device. Alternatively, an audible cue is provided to the user. Alternatively, a portion of the telepresence system vibrates to indicate the cause of misalignment to the user. Upon receiving a misalignment cue, the user is commanded by the telepresence system to return their head to a position corresponding to a position within the range of motion of the pan and tilt apparatus. Alternatively, the user is prevented by mechanical means from moving their head to a position corresponding to a position outside the range of motion of the pan and tilt apparatus. Once misaligned, the telepresence system is realigned by one of the methods described above.

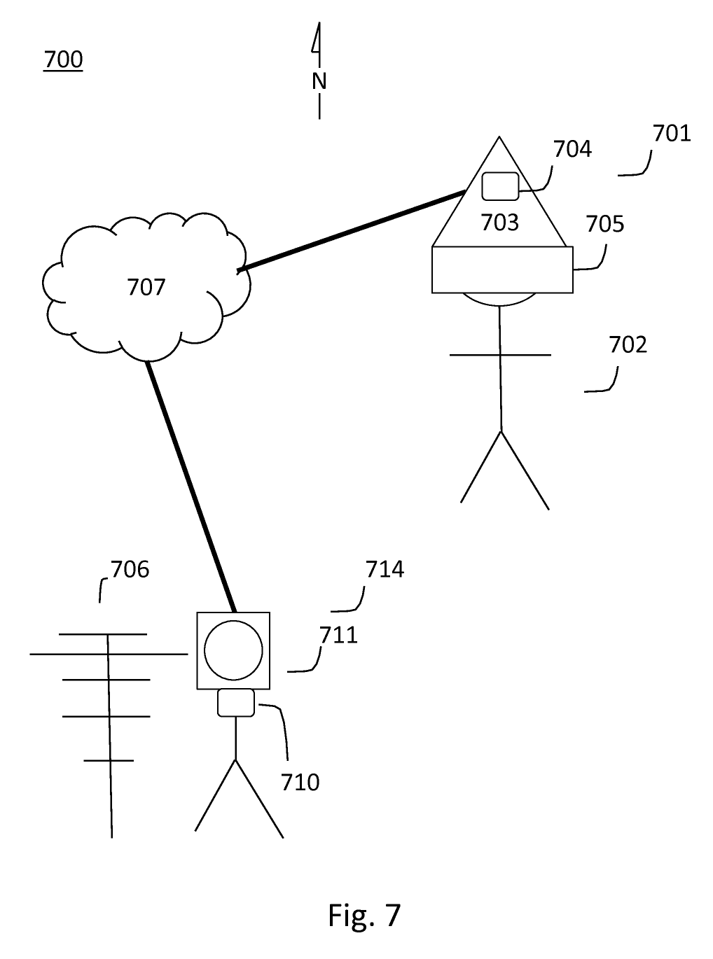

An obstruction to the movement of the pan and tilt apparatus also causes a misalignment between the position of the user's head and the pan and tilt apparatus. Shown in FIG. 7, is a simplified block diagram of a head tracking telepresence system obstructed by an object. Telepresence system 700 comprises a head mounted device 701, pan and tilt apparatus 714 and a communication network 707. Both the head mounted device 701 and pan and tilt apparatus 714 are coupled to communication network 707. The telepresence system also comprises a processor (not shown) coupled to the communication network 707 for processing data. In this example, head mounted device 701 comprises a helmet 703, display 705 and motion sensor 704 for sensing the movement of the head of user 702. Alternatively, the video display 705 is other than coupled to the head mounted device 701. Alternatively, the head mounted device comprises other than a helmet. Alternatively, the head mounted device comprises an apparatus for fixing a display to the user's head. Pan and tilt apparatus 714 is located remotely from user 702 and comprises video camera 711 and motor 710 for moving the camera in 3 dimensions. Alternatively, the pan and tilt apparatus 714 comprises a plurality of video cameras for providing stereoscopic vision to the user 702. Further alternatively, a plurality of motors are used for moving the cameras in 3 dimensions. In some embodiments the image is displayed on a video screen or a plurality of video screens.

West of the pan and tilt apparatus 714 is plant 706. User 702 moves their head directly west. Pan and tilt apparatus 714 tracks the movement of the user's head, however, it is obstructed by plant 706 and cannot move directly west. The telepresence system detects the misalignment caused by the obstruction. For example, by comparing feedback data comprising an indication of the position of pan and tilt apparatus 714 with the sensed position of the user's head, the misalignment is automatically detected by the processor. As the user's head position other than corresponds to a position outside the range of motion of the pan and tilt apparatus 714, the misalignment is deemed to be due to an obstruction and the user 702 is notified. For example, a text message appears on display 705. To correct for the misalignment due to an obstruction, a position {x1,y1,z1} is displayed on the display for guiding the user to move their head to that position. The user 714 moves their head to position {x1,y1,z1}. The pan and tilt apparatus 714 moves to the corresponding position {x1′,y1′,z1′}. Then the telepresence system resumes normal operation of tracking the user's head. Alternatively, the telepresence system mechanically guides the user's head to position {x1,y1,z1} and the pan and tilt apparatus moves to the corresponding position {x1′,y1′,z1′}. Alternatively, user 702 is requested to move their head to a previously known position and the pan and tilt apparatus moves to the corresponding position. Of course the user is not guided to a position that is unattainable due to the obstruction of plant 706. Alternatively, obstruction of the pan and tilt apparatus is determined by another method.

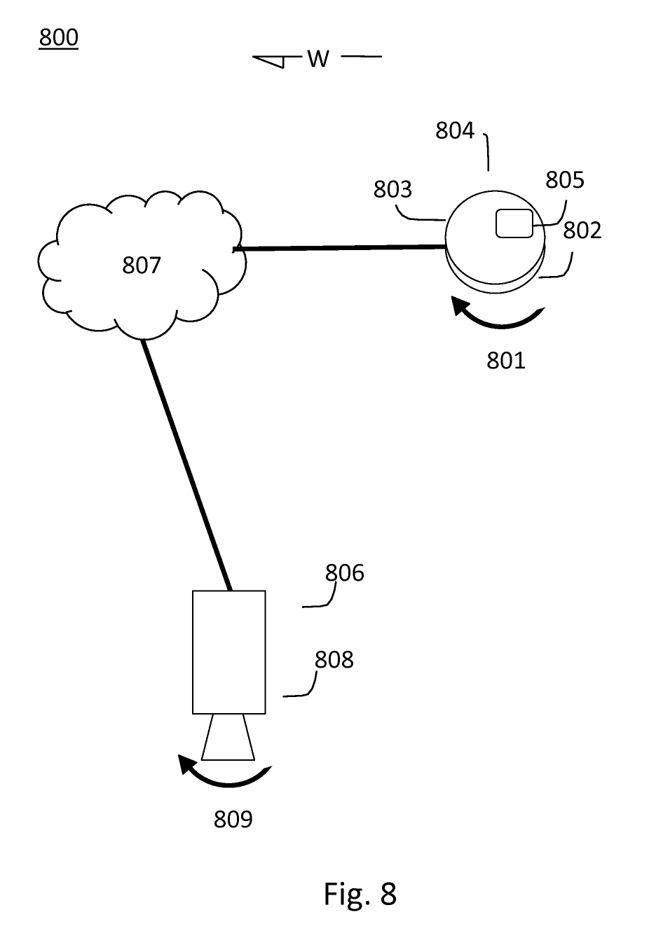

A delay in reaction time of the telepresence system also causes a misalignment between the position of the user's head and the pan and tilt system. Shown in FIG. 8, is a top view of a simplified block diagram of a telepresence system according to an embodiment of the invention. Telepresence system 800 comprises a head mounted device 804, pan and tilt apparatus 806 and a communication network 807. Both the head mounted device 804 and pan and tilt apparatus 806 are coupled to the communication network 807. The telepresence system also comprises a processor (not shown) coupled to the communication network 807 for processing data. In this example, head mounted device 804 comprises a helmet 803, display 802 and motion sensor 805 for sensing the movement of the head of a user. Alternatively, the head mounted device comprises other than a helmet. Alternatively, the head mounted device comprises an apparatus for fixing a display to a user's head. Alternatively, the video display 802 is other than coupled to the head mounted device 804. Pan and tilt apparatus 806 is located remotely from the user's location and comprises video camera 808 and motor (not shown) for moving the camera in three-dimensions. Alternatively, the pan and tilt apparatus 806 comprises a plurality of video cameras for providing stereoscopic vision to the user. Further alternatively, a plurality of motors are used for moving the cameras in 3 dimensions.

As the user moves their head to various positions, instructions are transmitted to the pan and tilt apparatus 806, via the communication network 807, instructing the pan and tilt apparatus 806 to move the video camera 808 such that it tracks the movement of the user's head. The movement of the pan and tilt apparatus 806 may lag the movement of the user's head. The lag depends on the speed of the user's head and the response time of the telepresence system. Video data is transmitted via the communication network 807 for displaying on display 802 the images captured by the video camera 808. For example, the user moves their head west as indicated by arrow 801, sensor 805 detects the motion and instructions are transmitted to the pan and tilt system 806 via communication system 807 to point toward the west. Pan and tilt apparatus 806 moves the video camera 808 towards the west as indicated by arrow 809. Image data showing west is transmitted to head mounted device 806 via communication network 807. As the user moves their head, the pan and tilt apparatus 806 follows, constantly transmitting video data for viewing by the user. Each position of the user's head corresponds to an aligned position of the pan and tilt apparatus 806. The user is ‘virtually immersed’ in the environment of the pan and tilt apparatus 806. In some embodiments the image is displayed on a video screen or a plurality of video screens.

Simultaneous to the movement of the user's head, feedback data indicating the instantaneous position of the pan and tilt apparatus 806 is provided to the processor. Also provided to the processor is the instantaneous position of the user's head. While in use, the pan and tilt apparatus 806 comes out of alignment with the position of the user's head. For example, the user's head is in position {x1, y1, z1} however pan and tilt apparatus 806 is in position {x3′,y3′,z3′}. Comparing the feedback data with the known positions of the user's head, the misalignment is automatically detected by the processor. It takes a response time of tr for the pan and tilt apparatus 806 to ‘catch up’ to the position of the user's head. The processor detects the lag in the response of the pan and tilt apparatus. Optionally, the telepresence system provides an indication to the user that a misalignment has occurred due to a lag in response time of the system. For example, a visual cue appears on the display. Alternatively, an audible cue is provided to the user. Alternatively, a portion of the telepresence system vibrates to indicate a misalignment due to lag in response time to the user. Alternatively, response time lag is detected by another method.

The embodiments presented are exemplary only and persons skilled in the art would appreciate that variations to the embodiments described above may be made without departing from the scope of the invention.

What is claimed is:

1. A method comprising:
sensing the movement of a head of a user with a first sensor;
providing by the first sensor a first signal indicative of the sensed movement of the head of the user;
coupling a second sensor to a vehicle and sensing the movement of the vehicle with the second sensor;
providing by the second sensor a second signal, the second signal comprising a component indicative of the sensed movement of the vehicle;
cancelling an error from the first signal comprising cancelling the component of the second signal indicative of the sensed movement of the vehicle to provide a third signal; and
moving a pan and tilt system in correlation with the third signal.

2. The method according to claim 1 wherein the user is a passenger of the vehicle, the cancelling for removing motion of the head of the user resulting from motion of the vehicle.

3. The method according to claim 1 wherein the pan and tilt system is aboard the vehicle, the cancelling for removing motion artefacts within feedback from the vehicle.

4. The method according to claim 1 wherein the error is cancelled for changing a relative position of the pan and tilt system to the vehicle during the movement of the vehicle.

5. The method according to claim 1 wherein the error is cancelled for changing a relative position of the pan and tilt system to the vehicle during the movement of the vehicle and movement of the head of the user, the change relating only to the movement of the head of the user.

6. The method according claim 1 wherein the error is cancelled for changing a relative position of the pan and tilt system to the vehicle during the movement of the vehicle and movement of the head of the user, the change relating to aligning motion of the pan and tilt system with the movement of the head of the user and filtering high frequency motion of the vehicle but other than related to low frequency motion of the vehicle.

7. The method according to claim 1 wherein cancelling the error reflected in the second signal comprises providing an indication to a user that an error is cancelled from the first signal to produce the third signal.

8. The method according to claim 1 comprising an input port from a user for receiving one of an ON and OFF signal, wherein dependent on the signal, the error in the first signal is other than cancelled.

9. A method comprising:
aligning a remote pan and tilt system (PATS) with the position of a head of a user wherein aligning comprises aligning the remote pan and tilt system with the position of the head of the user to define a set of aligned positions therebetween {(p1head,p1pats), (p2head, p2pats) (p3head, p3pats), . . . } such that moving the head of the user from a first aligned position p1head in alignment with the pan and tilt system at p1pats to a second other position p2head results in automatic motion of the pan and tilt system to a second PATS position p2pats in alignment with the second other position p2head;
after moving the remote pan and tilt system to maintain alignment with the movement of the head of the user, detecting automatically misalignment between a detected position of the remote pan and tilt system and a detected position of the head of the user; and
in response to automatically detecting misalignment, automatically realigning the relative position between the remote pan and tilt system with the head of the user to correct for the misalignment.

10. The method according to claim 9 wherein realigning the relative position comprises providing an indication to the user that the remote pan and tilt system and the head of the user is misaligned.

11. The method according to claim 9 comprising:
restricting motion of the head of the user to a first range of motion when a misalignment is detected.

12. The method according to claim 9 comprising:
detecting a position of the head of the user;
providing the detected position of the head of the user to a processor;
correlating the detected position of the head of the user with a known location of the pan and tilt system to determine when a position of the user's head is out of alignment with the pan and tilt system for determining that the pan and tilt system is obstructed; and
in response to detecting that the pan and tilt system is obstructed, guiding the head of the user to a first position p1head within the range of motion and positioning the pan and tilt system to the first position p1pats.

13. The method according to claim 12 comprising providing the user with an indication that movement of the pan and tilt system is obstructed.

14. The method according to claim 9 comprising:
detecting a position of the head of the user and rate of change of the position;
providing the detected position of the head of the user and the rate of change to a processor;
correlating the detected position of the head of the user with a known location of the pan and tilt system to determine when a position of the head of the user is out of alignment with the pan and tilt system for determining that head of the user is moving faster than the pan and tilt system; and
in response to detecting that the head of the user is moving faster, continuing to move the pan and tilt system toward a detected position of the head of the user.

15. The method according to claim 14 comprising providing the user with an indication that movement of the head of the user is faster than a speed of movement of the pan and tilt system.

16. The method according to claim 1 wherein the first sensor is worn by the user.

17. The method according to claim 1 wherein the vehicle is a remote vehicle for being controlled by the user.

18. A system comprising:
a first sensor for sensing movement of a head of a user and for transmitting a first signal indicative of the sensed movement of the head of the user;
a vehicle sensor for sensing movement of a vehicle and for transmitting a second signal indicative of the sensed movement of the vehicle;
a receiver for receiving the first signal and the second signal;
a processor for cancelling error based on the second signal from the first signal to produce a third signal; and
a remote pan and tilt system disposed remote from the first sensor and comprising a controller, movement of the remote pan and tilt system dependent upon the third signal.

19. The system according to claim 18 comprising an actuator for in response thereto disabling the cancelling error.

20. The system according to claim 18 comprising:
a head mounted device coupled to the head of the user wherein the first sensor is coupled to the head mounted device;
a video camera coupled to the pan and tilt system for capturing images; and
a display coupled to the head mounted device, the display for displaying to the user video images indicative of the images captured by the video camera.

21. The system according to claim 18 comprising:
a head mounted device coupled to the head of the user wherein the first sensor is coupled to the head mounted device;
a video camera coupled to the pan and tilt system for capturing images; and
a display other than coupled to the head mounted device, the display for displaying to the user video images indicative of the images captured by the video camera.
